(19) United States
(12) Patent Application Publication
(10) Pub. No.: US 2026/0099766 A1
(43) Pub. Date: Apr. 9, 2026

(54) ADAPTIVE DATA LOADER FOR BRIDGING LEGACY DATA SOURCES AND ARTIFICIAL INTELLIGENCE MODEL TRAINING

(71) Applicant: Lenovo Global Technology (UnitedStates) Inc., Morrisville, NC (US)

(72) Inventors: Jeffrey Daniel Esposito, North Kingstown, RI (US); Aishwarya Dharani Arul, Dallas, TX (US); Henry Svendsgaard, Durham, NC (US)

(21) Appl. No.: 19/064,832

(22) Filed: Feb. 27, 2025

Related U.S. Application Data
(60) Provisional application No. 63/703,786, filed on Oct. 4, 2024.

(51) Int. Cl. G06N 20/00

(52) U.S. Cl. CPC G06N 20/00

(57) ABSTRACT

A process includes identifying a plurality of legacy data sources, wherein each legacy data source has a unique legacy data format, and identifying, for each of the legacy data sources, a data loader that is adapted to process data from the legacy data source to form training data having a training data format that is different than the legacy data format. The process further includes causing, for each of the legacy data sources, the identified data loader to process at least a portion of the data from the legacy data source to form a batch of training data having the training data format. Still further, the operations comprise training an artificial intelligence model using the batches of training data formed from each of the legacy data sources.

### BACKGROUND

The present disclosure relates to data loader software that adds structure to a raw dataset for use by an artificial intelligence model.

### BACKGROUND OF THE RELATED ART

A Language Model (LM) is a statistical model used in Natural Language Processing (NLP) to understand and generate human language. A Large Language Model (LLM), such as OpenAI's GPT-3 or NVIDIA's NeMo framework, is a sophisticated and powerful version of a language model that is trained on vast amounts of text data to perform various language-related tasks. However, LLMs have some demonstrated drawbacks and limitations in the generative artificial intelligence space. These drawbacks include hallucinations, high training and computational costs, and data privacy concerns.

Language models may be used to leverage past experiences for various types of users. There are many use cases for such language models ranging from sales avatars that recall more than just what is in the shopping cart to chat bots that focus on technical set up and automation. However, while large language models are helpful in many use cases, they are not currently well-suited to address other use cases.

### BRIEF SUMMARY

Some embodiments provide a computer program product comprising a non-transitory computer readable storage medium and program instructions embodied therein, wherein the program instructions are configured to be executable by a processor to cause the processor to perform various operations. The operations comprise identifying a plurality of legacy data sources, wherein each legacy data source has a unique legacy data format, and identifying, for each of the legacy data sources, a data loader that is adapted to process data from the legacy data source to form training data having a training data format that is different than the legacy data format. The operations further comprise causing, for each of the legacy data sources, the identified data loader to process at least a portion of the data from the legacy data source to form a batch of training data having the training data format. Still further, the operations comprise training an artificial intelligence model using the batches of training data formed from each of the legacy data sources.

### BRIEF DESCRIPTION OF THE SEVERAL VIEWS OF THE DRAWINGS

FIG. 1 is a diagram illustrating legacy data sources being input to adaptive data loaders that provide datasets for unsupervised artificial intelligence (AI) model training, such as unsupervised language model (LM) training.

FIG. 2 is a flowchart of operations for training the AI model using one or more data loaders over a series of data batches and epochs.

FIG. 3 is a diagram of a dynamic spawn logic module and its interaction with legacy data sources and data loaders to process legacy data volumes for training of an AI model.

FIG. 4 is a flowchart of operations for adaptive learning rate logic according to one embodiment.

FIG. 5 is a diagram of a server according to some embodiments.

### DETAILED DESCRIPTION

Some embodiments provide a computer program product comprising a non-transitory computer readable storage medium and program instructions embodied therein, wherein the program instructions are configured to be executable by a processor to cause the processor to perform various operations. The operations comprise identifying a plurality of legacy data sources, wherein each legacy data source has a unique legacy data format, and identifying, for each of the legacy data sources, a data loader that is adapted to process data from the legacy data source to form training data having a training data format that is different than the legacy data format. The operations further comprise causing, for each of the legacy data sources, the identified data loader to process at least a portion of the data from the legacy data source to form a batch of training data having the training data format. Still further, the operations comprise training an artificial intelligence model using the batches of training data formed from each of the legacy data sources.

In some embodiments, the processor that will execute the program instructions is installed in a computer or server that is located in a cloud environment, a datacenter, a local area network, and/or an edge computing environment. As a non-limiting example, the operations performed in a cloud environment may be included in a legacy data pipeline service that enables users to process their legacy data sources to form datasets that are adapted for training of one or more artificial intelligence models. Such a legacy data pipeline service may include a collection of data loaders that have been prepared and tested to process a wide variety of legacy data types and versions. Accordingly, third party legacy data sources may be processed to form datasets that are adapted to support artificial intelligence training. A dataset is generally disconnected from the legacy data source and is created for a secondary purpose, such as the training of an artificial intelligence model.

A “legacy data source” refers to any previously deployed file, database or software asset that contains or produces data having a data structure, type, format or content that makes it a challenge to use in a newer system, such as in training of an artificial intelligence (AI) model. Data structure and data format refer to the specific way that data is organized and/or stored in a computer system. Data content refers to the actual information, substance, details or values within the data source regardless of its structure or format. In one non-limiting example, the legacy data source may use an outdated or old computing system, database program, or file format that is no longer actively supported and requires special handling. Alternatively, the legacy data source may simply be incompatible, unsuitable or suboptimal for use in training of an artificial intelligence model in a particular operating environment. Some legacy data sources contain vast amounts of useful data that has become isolated, deprecated, or unsuitable due to incompatibility with a modern or specialized computing system. It is a technical benefit that embodiments enable legacy data sources to be quickly and effectively prepared for training of an artificial intelligence model. In one option, a data source identification module may be provided for identifying and enumerating legacy data sources that will be used in the training of the artificial intelligence model. These legacy data sources may contain diverse data types and formats. Furthermore, each legacy data source may be classified into a category, such as text, images, etc., to guide preprocessing.

A “data loader” for use with an artificial intelligence model is a software component that efficiently reads and prepares data from a data source, delivering it to the artificial intelligence model or related training algorithm in a structured form and manageable batches for training or inference. The data loader may include one or more features, such as pre-processing, shuffling, data augmentation, and parallel loading to optimize the training process. The data loader may allow for customization, such as shuffling data before each epoch, applying data augmentation techniques, and setting the batch size. Pre-processing may include various operations, such as normalization, scaling, or text tokenization within the data loader so that these operations do not need to occur within a training script. In an example of training an artificial intelligence model to classify images, a data loader might read image files from a directory, resize them to a standard size, and then provide batches of images with their corresponding labels to the model. In an example of training an artificial intelligence model to understand text, a data loader could load text documents, tokenize them, and deliver batches of tokenized sentences with labels. A data loader for an artificial intelligence model may optionally use metadata about the training data to provide context about the training data that helps the model interpret and learn from the training data more effectively. In an example of textual training data, the metadata may identify the source of the text, publication date or topic category. In one option, the legacy data source may include data and metadata, wherein the data loader may use at least a portion of the data and at least a portion of the metadata to form the training data.

In some embodiments, the data loader is separately or externally developed for a particular legacy data source to ensure that the data loader is compatible with the data structure of the legacy data source, such as an Oracle database or SAP database, and will produce a training dataset having a data structure that is suitable for training the artificial intelligence model. Accordingly, the data loader input is the legacy data having the legacy data structure and the data loader output is a training dataset having a desired data structure for training of the artificial intelligence model. In one option, the data loader may process at least a portion of the legacy data source to form training data, such as one or more batches of training data, that can be used for unsupervised training of the artificial intelligence model. Unsupervised training refers to a process wherein the artificial intelligence model learns patterns and insights from unlabeled data, where the unlabeled data does not have predefined categories or target values. Accordingly, the artificial intelligence model must discover structure or relationships within the data without explicit human guidance or instruction. In an example of image analysis, an artificial intelligence model may be trained to group similar images together based on visual features without manually labeling each image. In an example of text analysis, an artificial intelligence model may be trained to identify topics within a large collection of text documents without pre-defining the topics. By contrast, supervised training or learning occurs where the data has been labeled with desired outcomes to train the model to predict specific results.

In some embodiments, a plurality of data loaders may each be identified by a version number that reflects the legacy data format(s) or version(s) that the data loader is designed to process. For example, a data source that is a relational database management system (RDBMS) may be based on various versions of the Structured Query Language (SQL) and the data loader for a particular relational database management system needs to be compatible with the particular SQL version that is used so that the unique functions and/or features of the SQL version may be used when reading from the database. Furthermore, one or more of the data loaders may use a library and/or application programming interface (API) for accessing and/or processing of the legacy data source.

In some embodiments, the operation of identifying, for each of the legacy data sources, a data loader that is adapted to process data from the legacy data source may include searching a plurality of data loader records. Specifically, the plurality of data loader records may be searched looking for a data loader record that identifies the legacy data source, wherein each data loader record identifies one of the legacy data sources and a data loader that is uniquely adapted to process the identified legacy data source. The legacy data source may be identified in various ways, such as using a legacy data volume or type and a legacy data version. After locating a data loader record that includes or identifies the legacy data source, the data loader included or identified within the same data loader record may be identified as being adapted to process the legacy data source. In other words, a data loader record may include a pairing of a specific legacy data source and a specific data loader that is adapted to process the legacy data source.

In some embodiments, the training data formed by each data loader differs from the legacy data source by the data format, data type and/or data structure. In one option, the training data format of the training data formed by each data loader is provided in a standardized file format for training of the artificial intelligence model. For example, the training data may be provided in a Portable Document Format (PDF).

A batch of training data is a subset of the overall training dataset that is used to update an artificial intelligence model during a single iteration of the training process. Specifically, the batch of training data is input to the artificial intelligence model during one iteration to calculate an error and adjust its parameters before proceeding to the next batch of training data. The size of the batch is a hyperparameter that specifies the number of data examples in each batch. Accordingly, the artificial intelligence model may be trained using the batches of training data formed from each of the legacy data sources.

The artificial intelligence model, such as a neural network, may be trained to perform natural language processing, computer vision, or audio processing. Many of the embodiments are described in terms of a language model (LM), but it should be recognized that the embodiments may also be applied to other artificial intelligence models. A language model (LM) is a type of artificial intelligence (AI) model that processes human language and provides responses or answers to user prompts or questions in a way that mimics human communication. Embodiments of the language model may include any of a number of language model architectures, such as a recurrent neural network architecture or a basic transformer architecture. A language model having a selected language model architecture may be trained on a training dataset, which may include any of a number of types of training data such as curated, unsupervised and/or self-supervised. Word embeddings represent words as vectors of real numbers in a multidimensional space. The language model may use word embeddings, such as a set of pre-trained, supervised word embeddings, to look up the numerical representation of a word.

Hyperparameters for the artificial intelligence model are configuration variables that are used to affect the training of the artificial intelligence model. For example, model hyperparameters are settings that control the architecture and complexity of the artificial intelligence model, such as the number of layers in a neural network, and algorithm hyperparameters are settings that control the process of training the artificial intelligence model, such as a learning rate or batch size. Each of the hyperparameters that are relevant to the selected artificial intelligence model architecture may be assigned a value that is used during training. Hyperparameter tuning refers to a process involving a sequence of experiments in which the artificial intelligence model may be trained using different sets of hyperparameter values to identify a set of hyperparameter values that produce a desired result.

In some embodiments, the operations may further comprise augmenting the training data formed from the legacy data source to enhance diversity of the training data, wherein the training of the artificial intelligence model uses the processed training data and the augmented training data. Data augmenting or data augmentation are techniques by which existing data is artificially modified to create new variations, effectively increasing the size and diversity of a training dataset, allowing artificial learning models to learn from a broader range of data and improve their performance, particularly when dealing with limited datasets. For example, where the dataset includes text, text data augmentation techniques may include synonym replacement, word shuffling, and paraphrasing. Optionally, each batch of training data may be separately augmented prior to an iteration of training the artificial intelligence model using the training data batch formed by the data loader.

In some embodiments, a monitoring and logging module may implement an adaptive learning rate, which may improve convergence during training. In the context of artificial intelligence model training, “convergence” refers to the point where the model reaches a stable state, meaning that its performance (perhaps measured by loss) no longer experiences significant improvements with continued training. Unlike scheduled decreases in the learning rate based on the number of training epochs completed, embodiments of the adaptive learning rate may increase the learning rate in response to the current performance of the artificial intelligence model being greater than an upper performance setpoint and/or decrease the learning rate in response to the current performance of the artificial intelligence model being less than a lower performance setpoint. In one option, the adaptive learning rate may be performed during each loop of a training method, such as after the artificial intelligence model has been trained on each data batch.

In some embodiments, the operations may include monitoring and logging of the artificial intelligence model operation at various stages during training. Accordingly, monitoring and logging may ensure that the artificial intelligence model operates correctly. The monitoring and logging of the artificial intelligence model performance may include both error handling and performance measurement. The error handling function may set an error severity at which additional data loader spawns will be stopped. In one option, a last good, spawned load is dropped in a recovery .log file in response to a significant error. In one option, the data loaders may each have a .log file with a corresponding name, with or without a toggle for verbatim and gross logging.

In some embodiments, a performance metric of the artificial intelligence model may be periodically evaluated using a validation dataset. Subsequently, the performance metric may form the basis for adjusting a learning rate that will be used in training of the artificial intelligence model on a subsequent data batch. This process may be repeated as needed, such as during a training iteration on each data batch. Specifically, if the performance metric exceeds the upper threshold, then the learning rate is increased by a small factor, such as a 20% increase from the previous learning rate. Conversely, if the performance metric falls below the lower threshold, then the learning rate is decreased by a small factor, such as a 20% reduction from the previous learning rate. In one option, the performance metric of the artificial intelligence model may be measured after the artificial intelligence model has been trained on each batch of training data. In another option, the process may end in response to a validation loss for the artificial intelligence model rising away from the training loss (i.e., the recent additional training is causing overfitting to the training data).

In some embodiments, the training of the artificial intelligence model may include fine-tuning the artificial intelligence model using the batches of training data formed from each of the legacy data sources. In other words, a pre-training artificial intelligence model, such as a pre-training language model, may be fine-tuned using one or more batches of training data formed by one of more of the data loaders from one or more legacy data source.

In some embodiments, the operations may further comprise determining whether output from the artificial intelligence model includes a hallucination, and fine-tuning the artificial intelligence model using the batches of training data formed from each of the legacy data sources in response to positively determining that the output from the artificial intelligence model includes a hallucination. Output from an artificial intelligence model may be checked for hallucinations using one or more methods, each with distinct approaches. One common method for detecting hallucinations includes fact-checking against trusted sources, where artificial intelligence model outputs are compared to verified databases, research papers, or authoritative websites to ensure accuracy. Another approach to detecting hallucinations includes consistency checks, which involves asking the artificial intelligence model the same question in different ways or multiple times to see if it produces stable and logical responses. Adversarial testing may also be used for detecting hallucinations, where the artificial intelligence model is intentionally given ambiguous or misleading prompts to observe if it generates false information. Human expert review remains a crucial method for detecting hallucinations, where domain specialists assess the artificial intelligence model's responses for errors and biases. Additionally, confidence scoring techniques may analyze the model's internal certainty in its answers, flagging low-confidence responses for further scrutiny as potential hallucinations. Any combination of these methods may be used to detect hallucinations so as to enhance artificial intelligence model reliability and factual accuracy.

In some embodiments, the operations may further comprise causing two or more of the data loaders to process data from two or more of the legacy data sources at the same time. This parallel processing of the separate legacy data sources facilitates fast and efficient formation of training data. In one alternative, the operations may further comprise causing two or more instances the same data loader to process data from the same legacy data source to form two or more batches of training data at the same time. Accordingly, multiple instances of a particular data loader may simultaneously form training data from the same legacy data source.

In some embodiments, the data loaders may be integrated with an artificial intelligence model training algorithm, such as an unsupervised language model training algorithm, so that the artificial intelligence model may be trained on the processed training data. In one option, a dynamic spawn logic module may dynamically spawn (launch) one or more data loaders, where each data loader is tailored to a different legacy data source. Optionally, the dynamic spawning of one or more data loaders may be performed in real-time. Furthermore, the dynamic spawning module may launch multiple data loaders to facilitate parallel processing of multiple legacy data sets or sources. The dynamic use of appropriate data loaders for the available legacy data sources enables compatibility, adaptability, and scalability of training data that will enhance the performance of the artificial intelligence model. A system using a plurality of data loaders to bridge legacy data to a generative neural network may be referred to as a metadata associative/interpretive dictionary (MAID), which is a backwards acronym referencing the concept of “cleaning up” data prior to its utilization in a training algorithm.

In some embodiments, the operations may further comprise requesting that one or more of the data loaders form an additional batch of training data, wherein the one or more data loaders form the additional batch of training data in response to receiving the request for additional batches of training data. The operations may then include obtaining the additional batch of training data and training of the artificial intelligence model using the additional batch of training data. Accordingly, the training logic or algorithm may obtain an additional batch of training data from a data loader upon request.

Some embodiments provide the technical benefit of simplifying data loading while positioning the data to make the most of autoencoding. This in turn helps to map data to two dimensions for visualization of patterns and their abstraction. In terms of transformer-based embedment, early experiments show minimized hallucination with no fine-tuning. This offers promise for current unidirectional or autoregressive transformers, such as a Generative Pre-trained Transformers (GPTs) that may be used in large language models (LLMs). An autoencoder is a type of neural network that learns to compress data into a lower-dimensional representation (latent space) and then reconstructs the original data from that compressed representation, which can be useful for dimensionality reduction and feature extraction. If the raw data has a high dimensionality, an autoencoder could be used as a preprocessing step to extract important features before feeding the data to the data loader. While both dimensionality reduction and feature extraction aim to reduce the complexity of data by lowering the number of features, the key difference is that dimensionality reduction simply reduces the number of variables in a dataset by projecting the data into a lower-dimensional space, while feature extraction creates new, meaningful features from the original data, potentially transforming the data into a different representation. Essentially, feature extraction involves extracting relevant information from the raw data to create a new set of features, whereas dimensionality reduction focuses on simply reducing the number of features without necessarily creating new ones. High dimensional data refers to data that has a large number of features or attributes, resulting in a high number of dimensions. High dimensional data may have a number of features or variables that exceeds the number of observations, making the data complex to analyze due to the sheer volume of information each data point contains.

A unidirectional transformer AI model is a type of transformer neural network that processes text data in only one direction (either left-to-right or right-to-left), meaning it only considers the context of the words that come before (or after) the current word when generating predictions, making it particularly suitable for tasks like text generation where predicting the next word is crucial; a prominent example of a unidirectional transformer model is GPT (Generative Pre-trained Transformer) which reads text sequentially from left to right. An autoregressive transformer AI model is a type of machine learning model that uses the transformer architecture to predict the next element in a sequence by relying solely on the previous elements in that sequence, essentially “auto-regressing” based on the past information to generate new data, like text, one piece at a time; popular examples include GPT (Generative Pre-trained Transformer) models which excel at generating coherent and contextually relevant text. Autoregressive transformers are often used for text generation tasks like writing creative text or translating languages, where the ability to build context progressively is crucial. Unidirectional transformers are better suited for tasks like sentiment analysis or text classification, where understanding the overall context from the beginning of the sequence is sufficient.

The foregoing computer program products may further include program instructions for implementing or initiating any one or more aspects of the methods described herein. Similarly, the operations performed by a processor executing the program instructions described herein may also be implemented as one or more methods or systems.

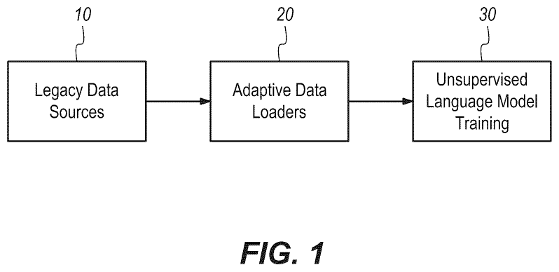

FIG. 1 is a diagram illustrating legacy data sources 10 being input to adaptive data loaders 20 that provide datasets for unsupervised training process or algorithm 30 for training an artificial intelligence (AI) model, such as a language model (LM). This represents the data loaders 20 as a bridge between the legacy data sources 10 and the unsupervised language model training 30. The data in the legacy data sources 10 has a format, structure, type or content that prevents the legacy data source from being directly suitable to training an artificial intelligence model. A collection of data loaders 20 is provided, including a specific data loader for each specific legacy data source, to process the data in the legacy data source 10 to form training data having a training data format, structure, type or content that is adapted for training 30 of the artificial intelligence model.

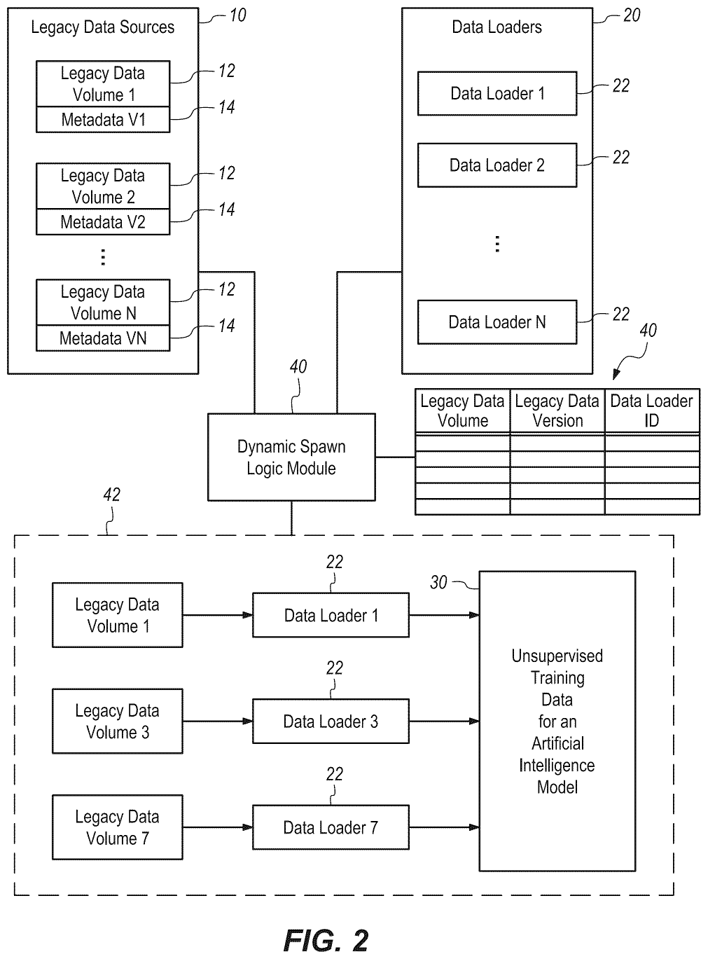

FIG. 2 is a diagram of a dynamic spawn logic module 40 and its interaction with the legacy data sources 10 and the data loaders 20 to process legacy data volumes for training of an artificial intelligence model 30. The legacy data sources 10 are show to include legacy data volumes or sources 12 (Legacy Data Volume 1 through Legacy Data Volume N), where each legacy data volume 12 is accompanied by some metadata 14 (Metadata V1 through Metadata VN).

The data loaders 20 includes a data loader 22 for each of the legacy data volumes 12 that are identified to be utilized to form training data 30. The data loaders 22 are identified by a version number or other identifier (i.e., 1 through N) that corresponds to the version number or other identifier of the legacy data volume or source 12 (i.e., 1 through N).

A dynamic spawn logic module 40 may have access to the legacy data source 10 and the data loaders 20 or at least access to cause the individual data loaders 22 to process the individual legacy data volumes or sources 12 and the metadata 14 associated with those individual legacy data volumes or sources 12 and metadata 14. The dynamic spawn logic module 40 stores a table or dictionary 40 that includes data loader records (illustrated as rows in a table) that identify each of the legacy data sources 12 (perhaps by legacy data volume and version) and a corresponding data loader identifier.

As illustrated at block 42, the dynamic spawn logic module 40 may launch multiple data loaders 22 (i.e., Data Loader 1, Data Loader 3 and Data Loader 7) and cause each the data loader, either simultaneously or upon request over time) to process the corresponding legacy data volume or source 12 (Legacy Data Volume 1, Legacy Data Volume 3 and Legacy Data Volume 7) to form one or more batches of training data 30.

In some implementations, a modular approach to general preprocessing may be used, for example so that the system can customize each step based on the specific data type. An example in the Python programming language is provided herein. Furthermore, this example assumes an already implemented set of specific preprocessors (‘text_preprocessing’, ‘image_preprocessing’, etc.):

```
“‘python
import os
from pathlib import Path
def load_data(directory_path):
  data = [ ]
  # Iterate through files in the directory
  for file_path in Path(directory_path).glob(″*.*″):
    with open(file_path, ′rb′) as file:
      content = file.read( )
      data.append(content)
  return data
def text_preprocessing(text):
  # Tokenization, removing stop words, etc.
  return processed_text
def image_preprocessing(image):
  # Resize, normalize, augment, etc.
  return processed_image
def audio_preprocessing(audio):
  # Spectrogram, noise reduction, etc.
  return processed_audio
def unsupervised_preprocessing(data):
  processed_data = [ ]
  for item in data:
    # Adapt based on data type (text, image, audio, etc.)
    processed_item = text_preprocessing(item)
    # Alternatively, you can call image_preprocessing(item) or
audio_preprocessing(item) based on data type
    processed_data.append(processed_item)
  return processed_data
# Example Usage:
if_{——}name_{——} == ″_{——}main_{——}″:
  # Load data
  raw_data = load_data(data_directory)
  # Preprocess data
  preprocessed_data = unsupervised_preprocessing(raw_data)
  # Print an example of original and preprocessed data
  print(″Original Data:″)
  print(raw_data[0])
  print(″\nPreprocessed Data:″)
  print(preprocessed_data[0])
“‘
```

In any specific application, the ‘text_preprocessing’, ‘image_preprocessing’, and ‘audio_preprocessing’ functions may be customized to suit the needs of an end user of preprocessed data. This modular approach allows easy adaptation of the preprocessing steps for different legacy data types in an unsupervised training context.

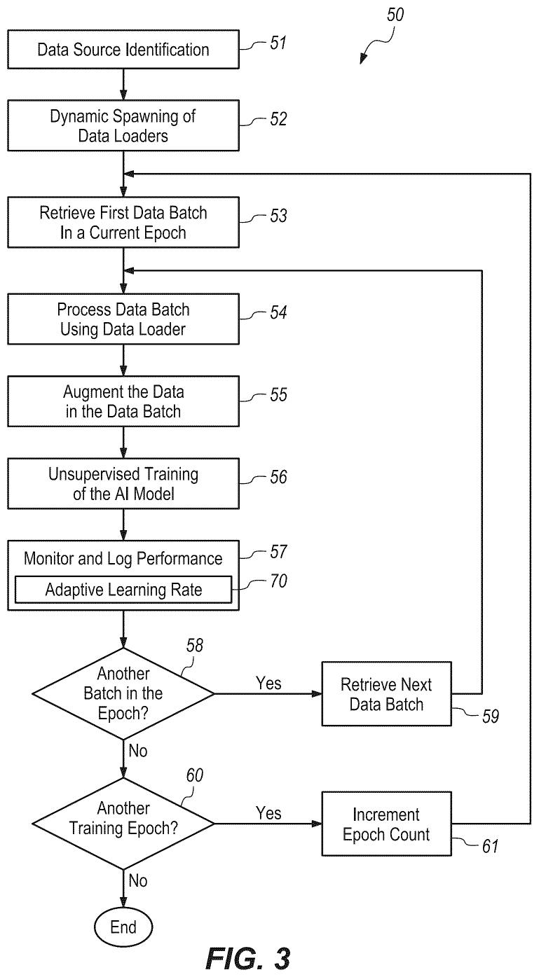

FIG. 3 is a flowchart of a process 50 for training an AI model using one or more data loaders over a series of data batches and epochs. Operation 51 includes data source identification, which may identify one or more legacy data sources that may be used as source of training data for an artificial intelligence model. Operation 52 includes dynamic spawning of data loaders such that the specific data loader(s) designed to process the identified legacy data source(s) is loaded or launched.

Operation 53 includes retrieving a first batch of data from the legacy data source and Operation 54 includes loading the corresponding data loader and the data loader processing the current data batch of the legacy data source to form training data in a format that is suitable for training the artificial intelligence model. Operation 55 includes an optional augmenting of the training data.

Operation 56 includes training the artificial intelligence model with the training data and any augmented data. For example, the training may be unsupervised training. Operation 57 includes monitoring the training progress and logging the performance of the artificial intelligence model. Operation 70 is directed to an adaptive learning rate in which a learning rate used by the training algorithm may be adjusted based upon the current performance of the model.

After Operations 54-57 and 70, Operation 58 includes determining whether there is another batch in the current training epoch. If there is another data batch in the current training epoch (see the “Yes” branch), then the process advances to Operation 59 to retrieve a next data batch before proceeding back to Operation 54 to load the corresponding data loader and process the next data batch. However, there is not another data batch in the current training epoch (see the “No” branch), then the process advances Operation 60.

Operation 60 includes determining whether the process 50 includes another training epoch. If there is another training epoch (see the “Yes” branch), then the process advances to Operation 61 to increment the epoch count before proceeding back to Operation 53 to a first data batch in the next training epoch. If there is no further training epoch (see the “No” branch), then the process ends. During the training process of FIG. 3, it should be recognized that the specific data loader that is being used may change from data batch to data batch depending upon the legacy data source from which the current data batch is being obtained. Furthermore, the loading of the data in batches means that the batches may be removed from memory after they have been used, such that the memory footprint of the algorithm is reduced.

The following is a non-limiting example of code (python) that may be used implement the process 50. This example assumes: functional coded modules/files for data adapters (‘legacy_data_adapters.py’), preprocessing (‘preprocessing.py’), augmentation (‘augmentation.py’), the language model (‘model.py’), and utility functions (‘utils.py’).

```
def main( ):
  # Step 1: Data Source Identification
  legacy_data_sources = [″source1.txt″, ″source2.csv″, ″source3.jpg″]
  # Step 2: Dynamic Spawning
  data_loaders = dynamic_spawn_data_loader(legacy_data_sources)
  # Step 3: Model Initialization
  language_model = LanguageModel( )
  # Step 4: Training Loop
  for epoch in range(num_epochs):
    for data_loader in data_loaders:
      for batch in data_loader:
        # Step 5: Legacy Integration & Preprocessing
        processed_data =
        preprocess_data(adapt_legacy_data_source(batch))
        # Step 6: Data Augmentation - see example code for data
        augmentation
        augmented_data = augment_data(processed_data)
        # Step 7: Model Training
        language_model.train(augmented_data)
    # Step 8: Monitoring and Logging
    monitor_performance(language_model, epoch)
  # Step 9: Save the trained model
  language_model.save_model(″trained_model.pth″)
if_{——}name_{——} == ″_{——}main_{——}″:
  main( )
“‘
```

In reference to the data augmentation (Step 6, above), the following is an example based upon image data handling uses the imgaug library for image data. However, data augmentation may be used to enhance the diversity of the training data whether the data type is image, audio or text.

```
“‘python
import imgaug.augmenters as iaa
import numpy as np
from PIL import Image
def augment_data(image_array):
  # Convert image_array to PIL Image format
  image = Image.fromarray(image_array)
  # Define augmentation pipeline
  augmenter = iaa.Sequential([
    iaa.Fliplr(0.5), # Horizontal flip
    iaa.Affine(rotate=(−30, 30)), # Random rotation
    iaa.GaussianBlur(sigma=(0, 1.0)), # Gaussian blur
    iaa.AdditiveGaussianNoise(scale=(0, 0.05*255)), # Gaussian noise
  ])
  # Apply augmentation
  augmented_image = augmenter(image=np.array(image))
  # Convert back to NumPy array
  augmented_array = np.array(augmented_image)
  return augmented_array
# Example Usage:
if_{——}name_{——} == ″_{——}main_{——}″:
  original_image = np.array(Image.open(image_path))
  # Perform augmentation
  augmented_image = augment_data(original_image)
  # Display original and augmented images
  Image.fromarray(original_image).show(title=′Original Image′)
  Image.fromarray(augmented_image).show(title=′Augmented Image′) “‘
```

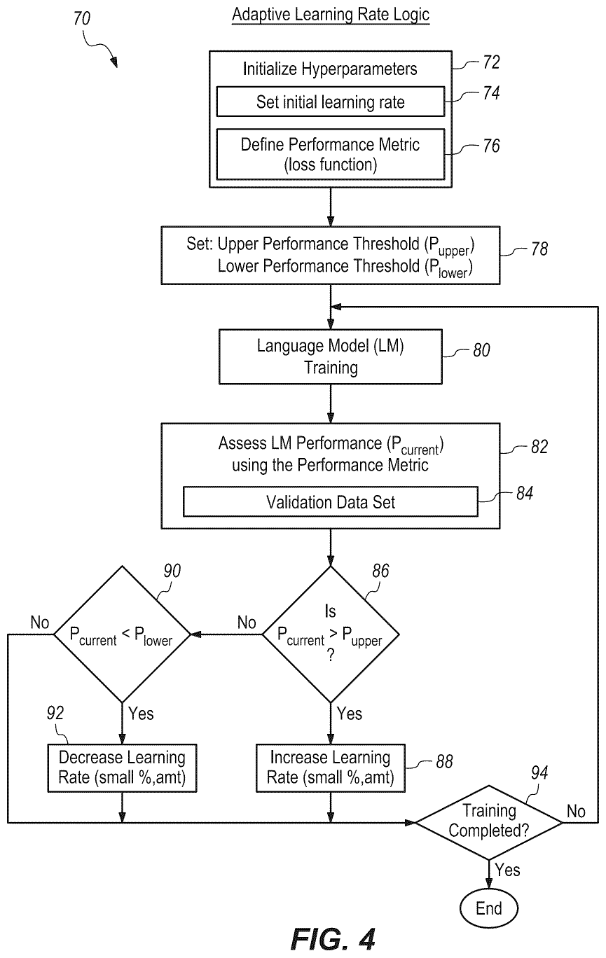

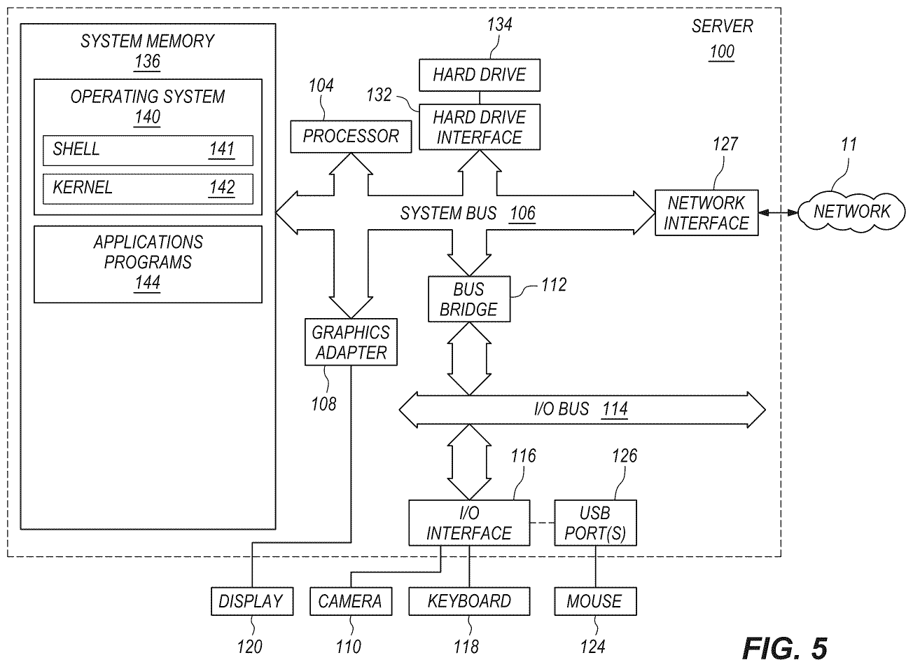

FIG. 4 is a flowchart of operations 70 for implementing adaptive learning rate logic according to one embodiment. A performance metric of the artificial intelligence model may be periodically evaluated using a validation dataset and the performance metric may form the basis for adjusting a learning rate that will be used in training of the artificial intelligence model on a subsequent data batch. This process may be repeated as needed, such as during a training iteration on each data batch, as shown in FIG. 5.

Operation 72 includes establishing a set of initial hyperparameters, such as an initial learning rate (LRᵢ) 74 and a performance metric 76 to monitor (e.g., loss function or evaluation metric). Operation 78 includes setting an upper performance threshold value (Pᵤₚₚₑᵣ) and a lower performance threshold value (P_{lower}) to be used to determine when to adjust the learning rate.

Operation 80 includes training of the artificial intelligence model, such as a language model (LM).

Operation 82 includes assessing or measuring the current performance metric value (P_{current}) of the artificial intelligence model after the artificial intelligence model has been trained on each batch of training data. The current performance metric valve (P_{current}) may be measured using a validation data set 84.

Operation 86 includes determining whether the current value of the performance metric is greater than the upper performance threshold value (i.e., is (P_{current})>(Pᵤₚₚₑᵣ)). In response to a positive determination (“Yes”) in Operation 86, then the process advances to Operation 88 to increase the learning rate, such as increasing the learning rate by a small factor, such as a 20% increase from the previous learning rate. In response to a negative determination (“No”) in Operation 86, then the process advances to Operation 90.

Operation 90 includes determining whether the current value of the performance metric is less than the lower performance threshold value (i.e., is (P_{current})<(P_{lower})). In response to a positive determination (“Yes”) in Operation 90, then the process advances to Operation 92 to decrease the learning rate, such as decreasing the learning rate by a small factor, such as a 20% decrease from the previous learning rate. In response to a negative determination (“No”) in Operation 90, then the process advances to Operation 94 without any adjustment of the learning rate. Operation 94 includes determining whether the training has been completed. If the training has not been completed (“No”), then the process returns to operation 80. However, if the training has been completed (“Yes”), then the process ends. In another option, the process may end in response to a validation loss for the artificial intelligence model rising away from the training loss (i.e., the recent additional training is causing overfitting to the training data).

FIG. 5 is a diagram of a computer or server 100 according to some embodiments. The server 100 may be representative of a web server or computer in the cloud environment that performs one of more of the processes 50, 70 and/or runs the artificial intelligence model after training.

The server 100 includes a processor unit 104 that is coupled to a system bus 106. The processor unit 104 may utilize one or more processors, each of which has one or more processor cores. An optional graphics adapter 108, which may or may not drive/support an optional display 120, is also coupled to system bus 106. The graphics adapter 108 may, for example, include a graphics processing unit (GPU). The system bus 106 may be coupled via a bus bridge 112 to an input/output (I/O) bus 114. An I/O interface 116 is coupled to the I/O bus 114, where the I/O interface 116 affords a connection with various optional I/O devices, such as a camera 110, a keyboard 118 (such as a touch screen virtual keyboard), and a USB mouse 124 via USB port(s) 126 (or other type of pointing device, such as a trackpad). As depicted, the computer 100 is able to communicate with other network devices over network(s) 11 using a network adapter or network interface controller 127.

A hard drive interface 132 is also coupled to the system bus 106. The hard drive interface 132 interfaces with a hard drive 134. In a preferred embodiment, the hard drive 134 may communicate with system memory 136, which is also coupled to the system bus 106. The system memory may be volatile or non-volatile and may include additional higher levels of volatile memory (not shown), including, but not limited to, cache memory, registers and buffers. Data that populates the system memory 136 may include the operating system (OS) 140 and application programs 144. The hardware elements depicted in the server 100 are not intended to be exhaustive but rather are representative.

The operating system 114 includes a shell 141 for providing transparent user access to resources such as application programs 144. Generally, the shell 141 is a program that provides an interpreter and an interface between the user and the operating system. More specifically, the shell 141 may execute commands that are entered into a command line user interface or from a file. Thus, the shell 141, also called a command processor, is generally the highest level of the operating system software hierarchy and serves as a command interpreter. The shell may provide a system prompt, interpret commands entered by keyboard, mouse, or other user input media, and send the interpreted command(s) to the appropriate lower levels of the operating system (e.g., a kernel 142) for processing. Note that while the shell 141 may be a text-based, line-oriented user interface, the present invention may support other user interface modes, such as graphical, voice, gestural, etc.

As depicted, the operating system 140 also includes the kernel 142, which includes lower levels of functionality for the operating system 140, including providing essential services required by other parts of the operating system 140 and application programs 144. Such essential services may include memory management, process and task management, disk management, and mouse and keyboard management. In addition, the computer server 100 may include application programs 144 stored in the system memory 136. In one example, the application programs 144 may include training process 50, the adaptive learning rate logic 70, the training artificial intelligence model, and/or a user interface to the artificial intelligence model.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A computer program product comprising a non-transitory computer readable storage medium and program instructions embodied therein, the program instructions being configured to be executable by a processor to cause the processor to perform operations comprising:
identifying a plurality of legacy data sources, wherein each legacy data source has a unique legacy data format;
identifying, for each of the legacy data sources, a data loader that is adapted to process data from the legacy data source to form training data having a training data format that is different than the legacy data format;
causing, for each of the legacy data sources, the identified data loader to process at least a portion of the data from the legacy data source to form a batch of training data having the training data format; and
training an artificial intelligence model using the batches of training data formed from each of the legacy data sources.

2. The computer program product of claim 1, wherein identifying, for each of the legacy data sources, a data loader that is adapted to process data from the legacy data source includes:
searching a plurality of data loader records for a data loader record that identifies the legacy data source, wherein each data loader record identifies one of the legacy data sources and a data loader that is uniquely adapted to process the identified legacy data source.

3. The computer program product of claim 1, wherein the artificial intelligence model is a language model.

4. The computer program product of claim 1, wherein the training of the artificial intelligence model includes unsupervised training of the artificial intelligence model using the batches of training data formed from each of the legacy data sources.

5. The computer program product of claim 1, wherein the training data format of the training data formed by each data loader is a standardized format for training of the artificial intelligence model.

6. The computer program product of claim 1, wherein the training data formed by each data loader differs from the legacy data source by the data format, data type and/or data structure.

7. The computer program product of claim 1, the operations further comprising:
augmenting the training data formed from the legacy data source to enhance diversity of the training data, wherein the training of the artificial intelligence model uses the processed training data and the augmented training data.

8. The computer program product of claim 1, wherein the training of the artificial intelligence model enables the artificial intelligence model to perform natural language processing, computer vision, or audio processing.

9. The computer program product of claim 1, the operations further comprising:
requesting that one or more of the data loaders form an additional batch of training data, wherein the one or more data loaders form the additional batch of training data in response to receiving the request for additional batches of training data;
obtaining the additional batch of training data; and
training of the artificial intelligence model using the additional batch of training data.

10. The computer program product of claim 1, the operations further comprising:
causing two or more of the data loaders to process data from two or more of the legacy data sources at the same time.

11. The computer program product of claim 1, the operations further comprising:
causing two or more instances the same data loader to process data from the same legacy data source to form two or more batches of training data at the same time.

12. The computer program product of claim 1, wherein the training of the artificial intelligence model includes fine-tuning the artificial intelligence model using the batches of training data formed from each of the legacy data sources.

13. The computer program product of claim 1, the operations further comprising:
determining whether output from the artificial intelligence model includes a hallucination; and
fine-tuning the artificial intelligence model using the batches of training data formed from each of the legacy data sources in response to positively determining that the output from the artificial intelligence model includes a hallucination.

14. The computer program product of claim 1, wherein the training data formed by the data loaders includes unlabeled data.

15. The computer program product of claim 1, wherein the legacy data source includes data and metadata, and wherein the data loader uses at least a portion of the data and at least a portion of the metadata to form the training data.

16. The computer program product of claim 1, wherein the legacy data source is a file, database or other collection of data.

17. The computer program product of claim 1, the operations further comprising:
measuring a performance metric of the artificial intelligence model during training using a validation dataset; and
adjusting a learning rate used in training of the artificial intelligence model on a subsequent data batch in response to the measured performance metric of the artificial intelligence model.

18. The computer program product of claim 1, the operations further comprising:
establishing an upper performance threshold value and a lower performance threshold value;
measuring a performance metric of the artificial intelligence model during training using a validation dataset;
decreasing the learning rate used in training of the artificial intelligence model on subsequent data batch in response to the measured performance metric less than the lower performance threshold value; and
increasing the learning rate used in training of the artificial intelligence model on subsequent data batch in response to the measured performance metric being greater than the upper performance threshold value.

19. The computer program product of claim 18, wherein the performance metric of the artificial intelligence model is measured after the artificial intelligence model has been trained on each batch of training data.

20. The computer program product of claim 1, wherein the legacy data sources include a plurality of data source versions having the same data source type, wherein each data loader is identified by a version number that reflects unique compatibility with one of the data source versions.
